(19) United States
(12) Patent Application Publication
(10) Pub. No.: US 2007/0104030 A1
(43) Pub. Date: May 10, 2007

(54) Measurement while drilling bi-directional pulser operating in a near laminar annular flow channel

(75) Inventors: David Kusko, Houston, TX (US); Peter Masak, West Chester, PA (US); Adrienne Masak-Rozier, West Chester, PA (US)

Correspondence Address: Guerry L. Grune, 784 S. Villier Ct., Virginia Beach, VA, 23452, US

(73) Assignee: Teledrill Inc., Allentown, PA (US)

(21) Appl. No.: 11/607,788

(22) Filed: Nov. 30, 2006

Related U.S. Application Data
(63) Continuation of application No. 10/956,708, filed on Oct. 1, 2004, now Pat. No. 7,180,826.

(51) Int. Cl. H04H 9/00; G01V 3/00

(52) U.S. Cl. 367/85; 340/854.3

(57) ABSTRACT

A device, method, and system for creating a pressure pulse from drilling fluid within a drill string in a down hole drill collar for enabling measurement-while drilling. The device and system are designed such that primarily laminar flow exists in the area surrounding the pulser apparatus. The method associated with the reproducible and essentially noise-free pulses occurs when a pulser bell is manipulated in an upward and downward direction by a combination of the solenoid activation of a bi-directional poppet to redirect the fluid flow from the pressure reservoir to and from a sliding pressure chamber and associated upper and lower flow connecting channels. The pulse or non-pulse is converted into a digital signal uphole by a pressure transducer in conjunction with a decoding algorithm. It is then displayed to the driller and oilfield operators as useful directional and formation information that help the oilfield operator for uphole decision making regarding directional drilling. Additional pulsers can be added to the tool so that higher data bit rates can be accomplished. These higher data bit rates will provide for more comprehensive data collection thereby reducing drilling costs and optimizing oil field yields. The higher bit rate allows for more sensors that can send additional and improved information uphole without the use of open hole wire line logging which is impossible to accommodate while drilling horizontally. Disclosed is a concentric, stream-line centralizer device, secured inside a drill collar and fastened to a measurement while drilling device, wherein a drilling fluid moves with a laminar flow within the drilling collar.

This application takes priority from U.S. patent application Ser. No. 10/956,708 filed on Oct. 01, 2004, titled: “Measurement While Drilling Bi-Directional Pulser Operating in a Near Laminar Annular Flow Channel”.

### BACKGROUND OF THE INVENTION

The current invention includes an apparatus and a method for creating a pressure pulse within drilling fluid that is generated by selectively activating solenoids that initiate flow driven bi-directional pulses. Features of the device include operating a pulser bell within a specially designed annular flow channel designed to reduce turbulent flow of the drilling fluid in a measurement-while-drilling device to provide for reproducible pressure pulses that are translated into relatively noise-free signals. The pulse is then received “up hole” as a series of signals that represent pressure variations which may be interpreted as gamma ray counts per second, azimuth, etc. by oilfield engineers and managers to recognize how to increase yield in oilfield operations.

Current pulser technology includes pulsers that are sensitive to different fluid pump down hole pressures, and flow rates, and require field adjustments to pulse properly so that meaningful signals from these pulses can be received by a programmable controller. Additional advantages of the present invention are that it remains insensitive to fluid flow rate or pressure, does not require field adjustment, and is capable of creating recognizable, repeatable, reproducible, clean (i.e. noise free) fluid pulse signals using minimum power due to a unique pulser bell and lower inner flow channel design thereby also eliminating the need for drilling preparation, a field engineer at the well site continuously, and downtime expenses. The annular flow channel is specifically designed such that primarily laminar flow exists in the area where the pulse occurs, thereby providing frequent essentially noise-free pulses and subsequent noise-free signals. Additional pulsers with varying pressure amplitudes are easily added to enable an exponential increase in the bit rate that is sent uphole. This will also allow the addition of more downhole sensors without losing formation resolution.

### DESCRIPTION OF PRIOR ART

The present invention discloses a novel device for creating pulses in drilling fluid media flowing through a drill string. Devices currently in use require springs or solenoids to assist in creating pulses and are primarily located in the main drilling fluid flow channel. Current devices also require onsite adjustment of the pulser according to the flow volume and fluid pressure and require higher energy consumption due to resistance of the fluid flow as it flows downward in the drill collar. The present inventive apparatus and assembly is also supported by a rigid centralizer facing the direction of fluid flow. The centralizer provides support for the assembly. The pulser assembly includes a fishing head and fluid screen assembly attachment at the top end facing the flow.

The device provided by the current invention allows for the use of a pulser bell that moves from an initial position to an intermediate and final position in both the upward and downward direction corresponding to the direction of the fluid flow. The present invention avoids the use of springs, the use of which are described in the following patents which are also herewith incorporated by reference in U.S. Pat. No. 3,958,217, U.S. Pat. No. 4,901,290, and U.S. Pat. No. 5,040,155. The present invention uses at least two solenoids and simple connecting channels in specific angular positions to provide for enhanced pressure pulses. The design of the present invention allows for a smaller overall annular flow channel thereby allowing for laminar-like flow which also provides for a higher sampling (bit) rate, improved data analysis, less energy consumption and greater reliability.

U.S. Pat. No. 5,040,155 to Feld, et. al. describe a double guided fluid pulse valve that is placed within a tube casing making the valve independent of movement of the main valve body and free of fluctuations of the main valve body. The valve contains a pressure chamber with upwardly angled passages for fluid flow between the pressure chamber and the main valve body. Double guides ensure valve reliability in the horizontal position.

U.S. Pat. No. 5,473,579 to Jeter, et. al., describes a pulser that utilizes a servo valve and spring acting upon each other to urge a signal valve to move axially within a bore with signal assistance coming from a counter balance compensator device.

U.S. Pat. No. 5,117,398 to Jeter describes a pulser device that uses electromagnetically opened latches that mechanically hold the valve in the closed or open position, not allowing movement, until a signal is received and the latches are electronically released.

U.S. Pat. No. 6,002,643 by Tchakarov, et al., describes a pulser device in which a bi-directional solenoid contains a first and second coil and a rod extending within the coils used to actuate a poppet valve creating bi-directional pressure pulses. Orifices to permit the flow of drilling fluid to be acted upon by the piston assembly within the main body of the pulser tool and a pressure actuated switch to enable the electronics of the control device to act upon the pulser tool.

U.S. Pat. No. 4,742,498 to Barron describes a pulser device that has the piston that is acted upon by the drilling fluid and is allowed seating and unseating movement by use of springs and an omni directional solenoid.

U.S. Pat. No. 6,016,288 to Frith discloses a servo driven pulser which actuates a screw shaft which turns and provides linear motion of the valve assembly. All components except the shaft are within a sealed compartment and do not come in contact with the drilling fluid.

U.S. Pat. No. 5,802,011 to Winters, et al., that describes a solenoid driven device that pivots a valve that enters and leaves the annular drilling fluid flow blocking and unblocking the fluid flow intermittently.

U.S. Pat. No. 5,103,430 to Jeter, et al., describes a two chamber pulse generating device that creates fluid chambers above and below a poppet valve that is servo driven. Pressure differential is detected on either side of the poppet through a third chamber and the servo is urged to move the poppet in order to stabilize the pressure differential.

U.S. Pat. No. 5,901,113 to Masak, et al., describes a measurement while drilling tool that utilizes inverse seismic profiling for identifying geologic formations. A seismic signal generator is placed near the drill bit and the generated known signals are acted upon by the geologic formations and then read by a receiver array.

U.S. Pat. No. 6,583,621 B2 to Prammer, et al., describes a magnetic resonance imaging device comprising of a permanent magnet set within a drill string that generates a magnetic flux to a sending antennae that is interpreted up hole.

U.S. Pat. No. 5,517,464 to Lerner, et al., describes a pulse generating device utilizing a flow driven turbine and modulator rotor that when rotated creates pressure pulses.

U.S. Pat. No. 5,467,832 to Orban, et al., describes a method for generating directional downhole electromagnetic or sonic vibrations that can be read up hole utilizing generated pressure pulses.

U.S. Pat. No. 5,461,230 to Winemiller, describes a method and apparatus for providing temperature compensation in gamma radiation detectors in measurement while drilling devices.

U.S. Pat. No. 5,402,068 to Meador, et. al., describes a signal generating device that is successively energized to generate a known electromagnetic signal which is acted upon by the surrounding environment. Changes to the known signal are interpreted as geological information and acted upon accordingly.

U.S. Pat. No. 5,250,806 to Rhein-Knudsen, et al., describes a device wherein the gamma radiation detectors are placed on the outside of the MWD device to physically locate them nearer to the drill collar in order to minimize signal distortion.

U.S. Pat. No. 5,804,820 to Evans, et al., describes a high energy neutron accelerator used to irradiate surrounding formations that can be read by gamma radiation detectors and processed through various statistical methods for interpretation.

U.S. Pat. No. 6,057,784 to Schaaf, et al., describes a measurement while drilling module that can be placed between the drill motor and the drill bit situating the device closer to the drill bit to provide more accurate geological information.

U.S. Pat. No. 6,220,371 B1 to Sharma, et al., describes a downhole sensor array that systematically samples material (fluid) in the drill collar and stores the information electronically for later retrieval and interpretation. This information may be transmitted in real time via telemetry or other means of communication.

U.S. Pat. No. 6,300,624 B1 to Yoo, et al., describes a stationary detection tool that provides azimuth data, via radiation detection, regarding the location of the tool.

U.S. Pat. No. 5,134,285 to Perry, et al., describes a measurement while drilling tool that incorporates specific longitudinally aligned gamma ray detectors and a gamma ray source.

U.S. application No. 2004/0089475 A1 to Kruspe, et.al., describes a measurement while drilling device that is hollow in the center allowing for the drilling shaft to rotate within while being secured to the drill collar. The decoupling of the device from the drill shaft provides for a minimal vibration location for improved sensing.

U.S. Pat. No. 6,714,138 B1 to Turner, et. al., describes a pulse generating device which incorporates the use of rotor vanes sequentially moved so that the flow of the drilling fluid is restricted so as to generate pressure pulses of known amplitude and duration.

G.B. Application No. 2157345 A to Scott, describes a mud pulse telemetry tool which utilizes a solenoid to reciprocally move a needle valve to restrict the flow of drilling fluid in a drill collar generating a pressure pulse.

International Application Number WO 2004/044369 A2 to Chemali, et.al., describes a method of determining the presence of oil and water in various concentrations and adjusting drilling direction to constantly maintain the desired oil and water content in the drill string by use of measuring fluid pressure. The fluid pressure baseline is established and the desired pressure value is calculated, measured and monitored.

International Publication Number WO 00/57211 to Schultz, et.al., describes a gamma ray detection method incorporating the use of four gamma ray sondes to detect gamma rays from four distinct areas surrounding a bore hole.

European Patent Application Publication Number 0 681 090 A2 to Lerner, et. al., describes a turbine and rotor capable of restricting and unrestricting the fluid flow in a bore hole thereby generating pressure pulses.

European Patent Specification Publication Number EP 0 781 422 B1 to Loomis, et. al. describes utilizing a three neutron accelerator and three detectors sensitive to specific elements and recording device to capture the information from the three detectors.

### SUMMARY OF INVENTION

The present invention discloses the placement of a pulser device including a pulser bell within an annular drill collar. The pulser design provides essentially four outer flow channels that allow fluid to flow. These are defined as the upper annular, the middle annular, lower annular, and centralizer annular collar flow channels. The inner lower and inner middle flow channels direct the fluid flow to the pulser bell apparatus within the measurement-while-drilling (MWD) device. Restricted annular fluid flow by the flow guide and pulser bell is essentially laminar and permits pulse signals that are more detectable, minimize the direct annular flow volume and change in pressure on the pulser device, and reduces energy consumption when compared with conventional devices.

Unique features of the pulser include the combination of middle and lower inner flow channels, pulser bell, poppet bellows, upper and lower flow connecting channels possessing an outlet angled opening and a dual solenoid system that creates signals in both the sealed and unsealed positions. Additional unique features include a flow guide for transitional flow and a sliding pressure chamber designed to allow for generation of the pressure pulses. The pulser bell slides axially on a pulser guide pole being pushed by the pressure generated in the pressure chamber when the poppet is in the seated position. Additional data (and increased bit rate) is generated by allowing the fluid to quickly back flow through the unique connecting channel openings when the poppet is in the unsealed position. Bi-directional axial movement of the pulser bell is generated by sequentially activating the push/pull solenoids. The signal generated provides at least twice the signal generation (bit rate) in comparison with conventional pulsers because of the bi-directional pulse feature. Cleaner signals are transmitted because the pulse is developed in near-laminar or completely laminar flow within the uniquely designed flow channels.

The method for generating pressure pulses in a drilling fluid flowing downward within a drill string includes starting at an initial first position wherein a bottom solenoid is activated such that a poppet (that can seat within a poppet seat which resides at the bottom of the middle inner flow channel) within a lower inner flow channel is not initially engaged. This allows for holding the poppet in this position with minimal current. The next step involves deactivation of the bottom solenoid and then a second top solenoid is activated, thereby moving the poppet into an engaged position. This motion seals a lower inner flow channel from the middle inner flow channel and forces the inner fluid into a pair of upper connecting flow channels, expanding the sliding pressure chamber, causing a pulser bell to move up toward a portion of a middle annular flow channel and stopping short of an orifice head, thereby causing a flow restriction. The flow restriction causes a pressure differential resulting in a pulse or pressure increase transmitted uphole. At the same time, fluid enters the exterior of the lower connecting flow channels, thus reducing the pressure drop across the poppet head seat. This allows for minimal force requirements for holding the poppet in the sealed position, thus saving a considerable amount of energy with respect to current designs. In the final position, the poppet moves back to the original or first position while allowing fluid to flow through a second set of lower connecting flow channels within the lower inner flow channel. This results in evacuating the sliding pressure chamber as fluid flows out of the chamber and back down the upper flow connecting channels into the middle inner flow channel and eventually into the lower inner flow channel. As this occurs, the pulser bell moves in a downward direction along the same direction as the flowing drilling fluid until motionless. This decreases the pulser bell-created pressure restriction of the main drilling fluid flow past the orifice head, resulting in a negative pulse.

### DETAILED DESCRIPTION OF THE INVENTION

The present invention will now be described in greater detail and with reference to the accompanying drawing. With reference now to FIG. 1, the device illustrated produces pressure pulses in drilling fluid flowing through a tubular drill collar [29] which can be stream-lined and concentric in shape and upper annular drill collar flow channel [2]. The flow guide [30] is secured to the inner diameter of the drill collar [29]. The centralizer [36] secures the lower portion of the pulse generating device and is comprised of a non-magnetic, rigid, wear resistant material with outer flow channels.

In the first (unsealed) position the poppet assembly [20] is not engaged within the poppet seat [19]. Energizing a bottom solenoid [33] pulls the actuator assembly [80] until it is flush with the bottom flux concentrator [35]. The solenoid actuator shaft [32], which is rigidly attached to the actuator assembly [80], moves to pull the poppet assembly [20] away from the poppet seat [19]. In the unsealed position, fluid flows past the fishing head [1] and mud screen assembly [3] where a portion of the fluid flows into the radially aligned slots [4] past the helical fluid screen [5] into the fluid screen assembly interior flow reservoir [6]. Fluid within the fluid screen assembly interior flow reservoir [6] flows into the transition [7] between the fluid screen reservoir and the middle inner flow channel [8] within the pulser guide pole [28].

Fluid flows past the upper flow connecting channels [25], sliding pressure chamber [26], and into the poppet seat [19] allowing the poppet assembly [20] to remain below the poppet seat [19]. This allows the fluid to flow into the lower inner flow channel [21], past the poppet bellows [22] and out of the lower flow connecting channels [23] into the lower annular drill collar flow channel [18]. Additionally, the fluid flows out of the constricting sliding pressure chamber [26] through the upper flow connecting channels [25] and past the poppet assembly [20] allowing the pulser bell [17] to move downward along the pulser guide pole [28] out of the throttle zone for pulse generation [14] thereby generating a negative pressure pulse and corresponding signal.

In the second (sealed) position the bottom solenoid [33] is de-energized and the top solenoid [31] is energized causing the actuator assembly [80] to be pushed until flush with the top flux concentrator [34]. The solenoid actuator shaft [32] then pushes the poppet assembly [20] until there is a seal with the poppet seat [19].

The lower inner flow channel [21] and the lower flow connecting channels [23] are effectively sealed so that fluid flow is completely restricted from above the poppet assembly [20]. As this sealing is achieved, fluid still enters the lower inner flow channel [21] via the lower connecting channel [23], thus almost equalizing the pressure across the poppet assembly [20]. The downward flow through the drill collar [29] causes the fluid to flow past the fishing head [1] and mud screen assembly [3] where a portion of the fluid flows into the radially aligned slots [4] past the helical fluid screen [5] into the fluid screen assembly interior flow reservoir [6]. The fluid next flows into the transition [7] between the fluid screen reservoir [6] and the middle inner flow channel [8]. Fluid then flows into the middle inner flow channel [8] through the upper flow connecting channels [25] and into the sliding pressure chamber [26] filling and expanding the sliding pressure chamber, causing the pulser bell [17] to rise along the pulser guide pole [28]. This effectively restricts the middle annular drill collar flow channel [12] from the lower annular drill collar flow channel [18], thereby generating a positive signal pulse at the throttle zone for pulse generation [14] and corresponding signal transmittal.

These conditions provide generation of a pulse as the pulser bell reaches both the restricted and unrestricted positions, thereby increasing the pulse generating rate over conventional measurement-while-drilling (MWD) devices. Most conventional devices only generate a signal pulse in a single direction. The present invention allows for several pulser bell assemblies (FIG. 1) to be placed in a drilling collar, thereby generating an exponential increase in the number of signals, further defining geological information that allows for improved oil field drilling efficiency.

Positioning of the pulser assembly (FIG. 1) within the drill collar [29] and utilizing the flow guide [30] significantly decreases the turbulence of the fluid. The fluid flow force required to move the poppet assembly into or out of the poppet seat is a nominal 3.5+/− pounds. Operational power consumption to retain the poppet in most positions is estimated to be 200 mA+/−. The linear motion of the pulser bell [17] axially along the pulser guide pole [28] is both up and down (along a bi-axial direction).

Conventional pulsers require adjustments to provide a consistent pulse at different fluid pump and down hole pressure and flow rates. The signal provided in the conventional technology is by a pulse that can be received up hole by use of a pressure transducer that is able to differentiate pressure pulses (generated downhole). These uphole pulses are then converted into useful signals providing information for the oilfield operator, such as gamma ray counts per second, azimuth, etc. Another advantage of the present invention is the ability to create a clean (essentially free of noise) pulse signal independent of the fluid flow rate or pressure within the drill collar. The present invention thereby allows for pulses of varying amplitudes (in pressure) that can be transmitted uphole with data bit rates that can be substantially increased to greater than 6 bits/sec by use of additional pulser assemblies and varying the restriction caused by the movement of the pulser bell. Addition of more than one pulser assembly would lead to an exponential increase in the data bit rate received uphole.

The connecting flow channels allow for equalization or at least achievement of near or complete equilibrium of the pressure across the poppet. The primary pressure change occurs between the inner middle and inner lower flow channels providing a pressure drop created by the pulser bell restricting the annular flow through the throttle zone. This minimal pressure drop across the poppet is the only force per unit area that must be overcome to engage or disengage the poppet from the seated position and effect a pulse. This minimal pressure drop across a minimal cross-sectional area of the poppet ensures that only a small force is required to provide a pulse.

While the present invention has been described herein with reference to a specific exemplary embodiment thereof, it will be evident that various modifications and changes may be made thereto without departing from the broader spirit and scope of the invention as set forth in the appended claims. The specification and drawing included herein are, accordingly to be regarded in an illustrative rather than in a restrictive sense.

### BRIEF DESCRIPTION OF THE DRAWINGS

FIG. 1A is a cut-away longitudinal sectional view of the pulser bell and associated apparatus of the present invention and references many of the critical features of the invention.

FIG. 1B is a continuation of the cross-sectional view shown in FIG. 1A and includes features that exist in an area below the pulser bell and associated apparatus including information regarding the solenoid actuation system and related components.

FIG. 1C is a further continuation of FIG. 1B, illustrating additional components used in measurement-while-drilling tools as well as the rigid centralizer required for the system of the present invention.

FIG. 2 is the compilation of FIGS. 1A, 1B and 1C.

### DETAILED DESCRIPTION OF THE DRAWINGS

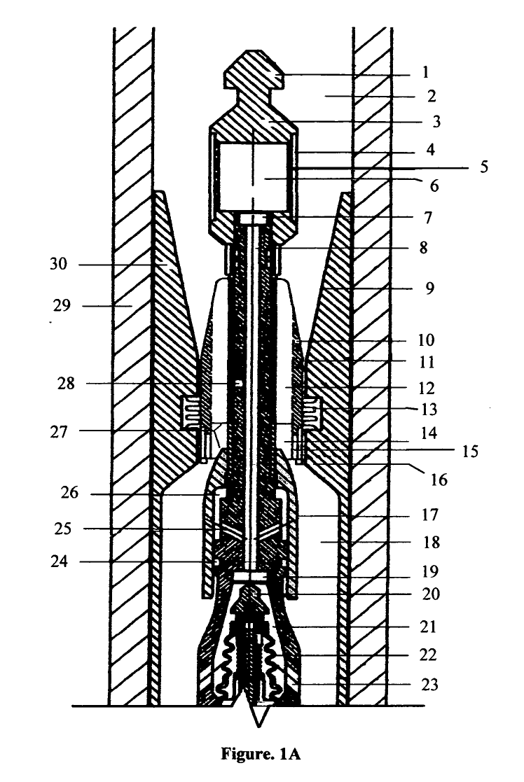

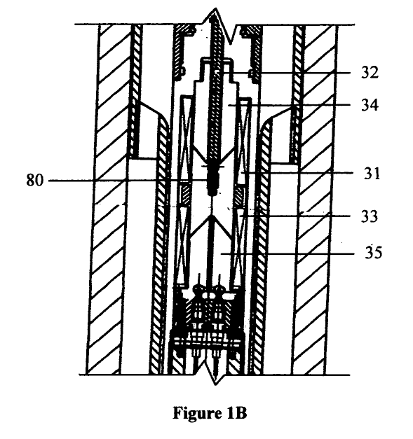

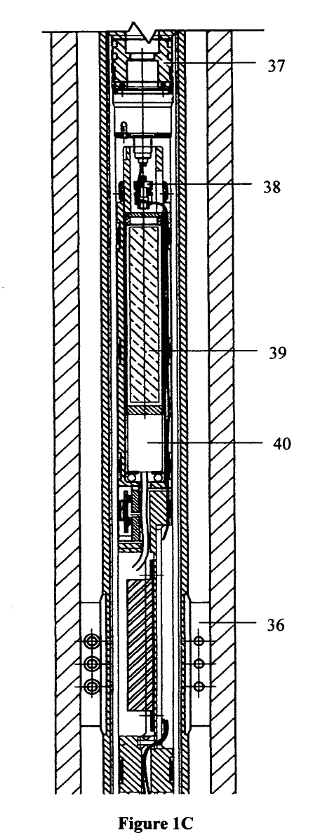

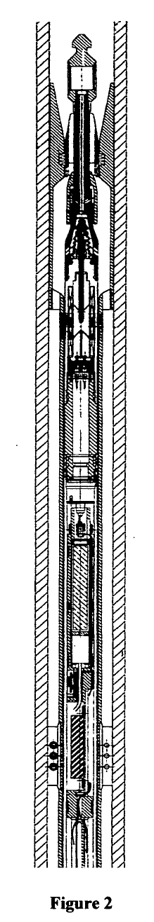

The present invention will now be described in greater detail referring specifically to the accompanying drawings. With reference to FIGS. 1A, 1B and 1C, as well as FIG. 2, the MWD device. For FIG. 1A, there exists a tubular drill collar [29] and upper annular drill collar flow channel [2]. A flow guide [30] is secured to the inner diameter of the drill collar [29]. The centralizer (shown in FIG. 1C) [36] secures the lower portion of the pulse generating device and is comprised of a non-magnetic, rigid, high temperature, wear resistant material with outer flow channels.

A poppet assembly [20] restricts and permits drill fluid flow through a poppet seat [19]. As shown in FIG. 1B, a rear solenoid [31] actuates the right flux concentrator [33] the solenoid actuator shaft [35] and poppet assembly [20]. Referring back to FIG. 1A, a fishing head [1] and mud screen assembly [3] contain radially aligned slots [4] a helical fluid screen [5] and a fluid screen assembly interior flow reservoir [6]. Fluid within the fluid screen assembly interior flow reservoir [6] flows into the transition between the fluid screen reservoir and inner flow channel [7] and the middle inner flow channel [8] within the pulser guide pole [28].

Fluid flows past the upper inner flow connecting channels [25] sliding pressure chamber [26] and into the poppet seat [19] allowing the poppet assembly [20] to remain below the poppet seat [19], thereby allowing the fluid to flow into the lower inner flow channel [21], past the poppet bellows [22] and out of the lower inner flow connecting channels [23] into the lower annular drill collar flow channel [18]. Additionally the material flows from the sliding pressure chamber [26] through the upper inner flow connecting channels [25] and past the poppet assembly [20] allowing the pulser bell [17] to move downward along the pulser guide pole [28] out of the throttle zone for pulse generation [14].

A rear solenoid [31] and front solenoid [34] is energized causing the left flux concentrator [32] and solenoid actuator shaft [35] to push the poppet assembly [20] to seal against the poppet seat [19].

FIG. 2 is a compilation of FIGS. 1A, 1B and 1C and is provided so that a full detailed view of the subject of the invention is understood. The complete device and system is featured in FIG. 2 a system.

What is claimed is:

1. A centralizer device comprising a pulse generating device secured within a tubular drill collar wherein drilling fluid flows, with an apparatus designed for securing a pulser apparatus longitudinally within said drill collar.

2. The centralizer of claim 1, wherein said tubular drill collar is a rigid concentric shape and wherein said centralizer faces the direction of said drilling fluid.

3. The centralizer of claim 1, wherein said centralizer provides a means for securing said pulse generating device.

4. The centralizer of claim 1, wherein said centralizer provides for annular flow channels allowing for unrestricted flow of said drilling fluid.

5. The centralizer of claim 1, wherein said centralizer is constructed of rigid, non-magnetic, wear resistant material.

6. The centralizer of claim 1, wherein said centralizer is secured within an inner diameter of said tubular drill collar.

7. A centralizer device comprising a stream-lined design secured within a tubular drill collar for a measurement-while-drilling device with a flow guide wherein drilling fluid flows, comprising a design useful for securing a pulser apparatus longitudinally within said drill collar.

8. The centralizer of claim 7, wherein said centralizer is a rigid concentric shape and wherein said centralizer faces the direction of said drilling fluid.

9. The centralizer of claim 7, wherein said centralizer provides a means for securing said measurement-while-drilling device.

10. The centralizer of claim 7, wherein said centralizer provides for annular flow channels allowing unrestricted flow of said drilling fluid and whereby said drilling fluid is flowing primarily in a laminar flow mode significantly reducing turbulence of said drilling fluid.

11. The centralizer of claim 7, wherein said centralizer is constructed of rigid, non-magnetic, wear resistant material.

12. The centralizer of claim 7, wherein said centralizer can be secured within an inner diameter of said tubular drill collar.
